(19) United States
(12) Patent Application Publication
(10) Pub. No.: US 2022/0393492 A1
(43) Pub. Date: Dec. 8, 2022

(54) BATTERY STORAGE AND ALLOCATION

(71) Applicant: POWER.GLOBAL, PBC, Pasadena, CA (US)

(72) Inventors: W. Porter Harris, Pasadena, CA (US); Nader Lotfy, Pasadena, CA (US)

(21) Appl. No.: 17/826,695

(22) Filed: May 27, 2022

Related U.S. Application Data
(60) Provisional application No. 63/195,905, filed on Jun. 2, 2021.

(51) Int. Cl. H02J 7/00; H02J 7/02; H02J 3/32

(52) U.S. Cl. CPC H02J 7/0045; H02J 7/0013; H02J 7/02; H02J 3/32; H02J 7/005; H02J 7/0048; H02J 2207/20

(57) ABSTRACT

A system for battery management, such as a kiosk, can include a plurality of battery holders. Each battery holder can have a lock that retains or releases a battery pack that is held in the respective battery holder. For each battery holder, a bidirectional inverter can have an alternating current (AC) stage that is electrically coupled to an AC bus, and a direct current (DC) stage that is electrically coupled to the battery pack in the respective one of the plurality of battery holders. Other aspects are described.

### CROSS REFERENCE TO RELATED APPLICATIONS

This application claims the benefit of U.S. Provisional Patent Application No. 63/195,905 filed Jun. 2, 2021, which is incorporated by reference herein in its entirety.

### TECHNICAL FIELD

Aspects of the disclosure relate to energy storage. In particular, aspects relate to system for storing and allocating battery packs.

### BACKGROUND

Lithium-ion based battery cells have a high energy density and are rechargeable. They are popular for a variety of energy storage applications such as cell phones, laptops, and electric vehicles. Battery cells can be grouped into units called battery packs. These battery packs can be used to power vehicles such as cars, bikes, scooters, rickshaws, and other electrically powered vehicles. Energy drains from battery packs when they are used. At some point, a user may look to charge the battery packs, or risk being stranded without energy to power the vehicle.

Charge stations can have DC fast chargers that can recharge a depleted battery in a relatively short time (e.g., 15-30 minutes). Users can also charge the depleted batteries with slower chargers that have slower power charging capabilities, however, these slower chargers can be plugged into outlets similar to other home appliances.

### SUMMARY

In some aspects of the present disclosure, a system for battery management, includes a plurality of battery holders; a plurality of locks, each being operated by processing logic to retain or release a battery pack in a respective one of the plurality of battery holders; and a plurality of bidirectional inverters, each having an alternating current (AC) stage that is electrically coupled to an AC bus that is common to all of the plurality of bidirectional inverters, and a direct current (DC) stage that is electrically coupled to the battery pack in the respective one of the plurality of battery holders.

A user can slide a depleted battery pack into any empty battery holder. One of the plurality of locks can retain the respective battery in the holder. Processing logic can release a second battery pack to the user. This second battery pack can be charged, so that the user can be on her way with the charged battery pack. The bidirectional inverters can be controlled individually to charge or to discharge each battery pack. One or more of the battery packs can be discharged into the common AC bus, which can be connected to one or more loads. As such, the system can serve as a kiosk and a back-up energy storage device (e.g., an uninterruptible power source (UPS)).

The above summary does not include an exhaustive list of all embodiments of the present disclosure. It is contemplated that the disclosure includes all systems and methods that can be practiced from all suitable combinations of the various embodiments summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several embodiments of the disclosure here are illustrated by way of example and not by way of limitation in the figures of the accompanying drawings in which like references indicate similar elements. It should be noted that references to “an” or “one” embodiment in this disclosure are not necessarily to the same embodiment, and they mean at least one. Also, in the interest of conciseness and reducing the total number of figures, a given figure may used to illustrate the features of more than one embodiment of the disclosure, and not all elements in the figure may be required for a given embodiment.

FIG. 1 shows a system for battery management, according to some embodiments.

FIG. 2 shows a system for battery management with a network, according to some embodiments.

FIG. 3 shows a method for battery storage and allocation, according to some embodiments.

FIGS. 4, 5, and 6 show examples of battery charging and discharging, according to some embodiments.

FIG. 7 shows a system for battery allocation based on state of charge (SOC), according to some embodiments.

FIG. 8 shows a system for battery allocation based on state of health (SOH), according to some embodiments.

FIG. 9 shows method for granting or denying a request to reserve or release a battery pack based on criteria, according to some embodiments.

FIG. 10 shows method for granting or denying a request to reserve or release a battery pack based on criteria that includes grid presence, according to some embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended statements.

For the sake of brevity, conventional techniques for battery pack construction, configuration, and use, as well as conventional techniques for thermal management, operation, measurement, optimization, and/or control, may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical system or related methods of use.

Battery packs can be used for transportation of vehicles. Battery packs can become depleted due to usage, thus requiring a user to recharge. A user can map a route in advance to reduce the chance that the batteries deplete in-route. A user can locate charge stations along the route, which can be used to charge the batteries and reduce risk of being stranded. Charging stations can be lacking or sparse in some areas. Further, recharging batteries may be time-consuming, and thus, some users may wish to swap a depleted battery pack with a new battery pack rather than wait for the depleted battery pack to recharge.

Utility companies maintain networks of power lines that are connected to one or more power sources, such as a large generator, solar farm, wind farm, coal plant, nuclear plant, a dam-powered generator, or other power sources. Acts of nature such as wind, rain, etc.; deteriorating infrastructure; excessive demand; human error; or mischievous animals, can cause disruptions to power lines, resulting in a temporary loss of power to areas that are serviced. In some areas, this loss of power occurs frequently, due to excessive demand and/or an inadequate power infrastructure. The power sources may not be adequate to support peak demands.

A battery storage and allocation system can serve as a kiosk for users to swap batteries, while also using one or more of the battery packs as a back-up energy storage. Bidirectional inverters for each battery pack provide increased flexibility in energy sharing between battery packs, and between any of the battery packs and the grid.

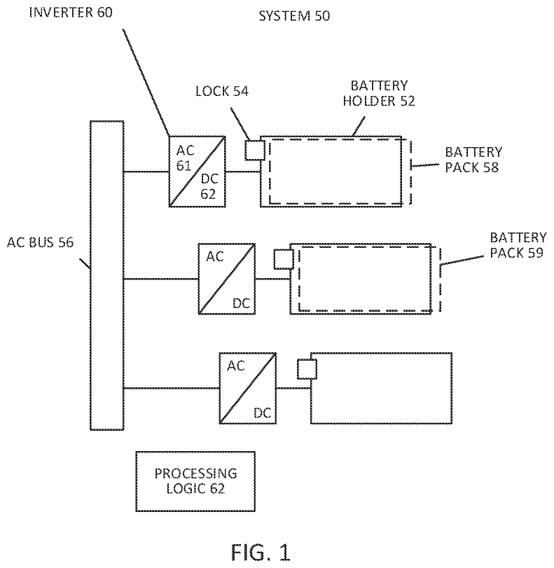

FIG. 1 shows a system 50 for battery management, according to some embodiments. The system can include a plurality of battery holders 52 (e.g., two or more). Each of the battery holders can have a corresponding one of a plurality of locks 54. Each lock can be operated by processing logic 62 to retain or release a battery pack in a respective one of the plurality of battery holders.

As such, the system can accept a battery pack 58 from user. The user can place the battery pack (e.g., a depleted battery pack) into an empty battery holder 52. Processing logic can automatically lock this battery pack in place, thereby retaining the battery pack in the battery holder. From a different battery holder, the system can release a charged battery 59 to the user. As such, the system can facilitate a battery swap. The user can be on her way with a charged battery, without delay of charging the depleted battery.

A lock can include one or more members that hold the battery in place, such as a pin, threads, a threaded pin, a latch, a clip, a spring, etc. Additionally, or alternatively, the lock can include a magnetic lock that uses magnetic force to hold or release the battery pack. The lock can include an actuator such as a solenoid, motor, or other actuator. The lock can be controlled electronically by processing logic, e.g., through an electronic signal, to release or retain the battery.

In some aspects, a lock can have a normally locked position, such that when a user slides a battery pack into a battery holder, a lock can spring into place to hold the battery pack in the battery holder. Processing logic can send a command to the lock to release the battery pack, based on a user request, which can include a user input pressing one or more buttons, or entering a password, a numerical combination, or other verification hurdle.

In some embodiments, processing logic can require a user to swap a battery pack in order to release a battery pack to the user. A user request to swap the battery at a current time or at a later time can be treated by processing logic as equivalent to a user request to release or reserve a battery, respectively, as described in other sections. Processing logic can apply one or more criteria, as described in other sections, to determine whether or not to grant the user request, and if so, which battery pack to release. If the user request for swap is denied, processing logic can return the battery pack to the holder, by releasing the lock or keeping it in a released state. Thus, processing logic may, in some embodiments, require an exchange of batteries to release a battery. In some embodiments, processing logic can treat a user inserting a battery pack into the battery holder as a user request for releasing another battery pack. For example, when a user inserts a battery pack into a battery holder, processing logic can determine whether or not to release another battery pack from another battery holder.

In some aspects, the lock includes a pin that is inserted into the battery pack. Processing logic rotates the pin so that threads on the pin will pull and hold the battery pack in place, thereby locking and retaining the battery pack in the holder.

Actuation of the lock by processing logic can be performed in response to sensing that the battery pack is in position to be locked. One or more sensors, such as an active IR sensor, an ultrasonic sensor, photovoltaic sensor, a resistive sensor or other sensor can detect when a battery pack is positioned in place in the battery holder.

Processing logic 62 may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

The system can include a plurality of bidirectional inverters 60, each having an alternating current (AC) stage 61 that is electrically coupled to an AC bus 56. The AC bus can be common to all of the plurality of bidirectional inverters, which allows for flexibility in energy allocation, as described in other sections. Each of the bidirectional inverters can have a direct current (DC) stage that is electrically coupled to the battery pack through the respective one of the plurality of battery holders. The AC stage and the DC stage can include a combination of power electronic components such as plurality of power switching devices (e.g., MOSFETs, IGBTs, transistors, FETs, BJTs, diodes, etc.), resistors, capacitors, inductors, and switching logic. Switching logic can include one or more of a digital signal processor, field programmable gate array (FPGA), a system on chip (SOC) to drive the power switching devices open and closed. The power electronic components can be arranged in one or more electronic circuits such that, when the power switching devices are switched, causes an AC voltage to be present at the output of the AC stage, and a DC voltage to be present at the output of the DC stage. By controlling the switching of the power switching devices (e.g., the duty cycles and/or frequency thereof), the bidirectional inverter can deliver electrical energy to the AC output from the DC output, or vice versa. The electronic circuits can be arranged in one or more power switching topologies such as buck-boost converter for the AC stage and buck-boost converter for the DC stage. The components can be arranged in various different electronic circuits and topologies to form a bidirectional inverter without departing from the scope of the present disclosure.

The DC stages can be coupled to different battery packs to individually control whether a battery pack charges or discharges, and at what current each battery pack charges and discharges. Processing logic can retain one or more of the battery packs (e.g., battery pack 58) and withhold the one or more battery packs to be used as back-up energy storage.

Retaining a battery pack can refer to holding one or more of the battery packs in a respective battery holder with a respective lock. Withholding a battery pack can refer to denying a user's request to release a battery pack, and/or denying a user's request to reserve a battery pack. Processing logic can withhold a battery pack based on one or more conditions, as described in other sections.

Battery packs that are withheld are not available for a user to take from the battery holder. The withheld battery packs can be reserved for when a power outage occurs. In such a case, the bidirectional inverters can be configured to sense when a power outage occurs and direct energy from a respective battery pack to the AC bus. As such, the system can serve as a kiosk and a back-up energy storage device (e.g., an uninterruptible power source (UPS)). In some embodiments, processing logic can perform executive functionality such as responding to when a power outage has occurred, which direction each of the bidirectional inverter should be operating in, and/or a power of each bidirectional inverter. Processing logic can provide commands to each bidirectional inverter through one or more communication buses. Each bidirectional inverter can also communicate with processing logic by providing status such as current, voltage, fault detection, and more. Processing logic can also communicate with each battery pack (e.g., a BMS of the battery pack) over one or more communication buses.

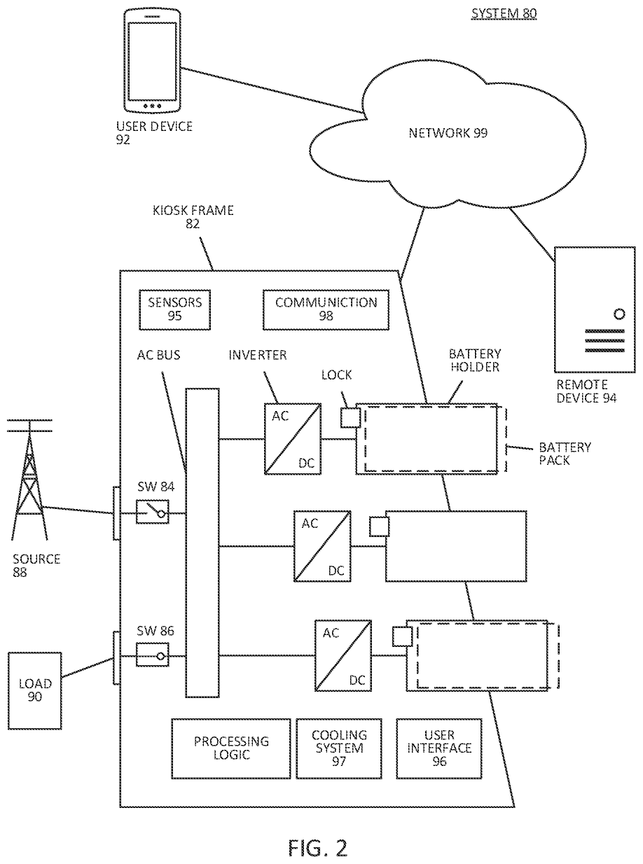

FIG. 2 shows a system 80 for battery management with a network and other optional features, according to some embodiments. The system includes components described with respect to FIG. 1 such as the battery holders, locks, bidirectional inverters, processing logic, and AC bus. These components can be housed in a common kiosk frame 82. In some embodiments, some or all of the processing logic can be located externally, such as in a remote device 94. The system can include a communication unit 98 which can include wired or wireless transmitters and receivers which can be referred to collectively as a transceiver. The transceiver can communicate with other computing devices over a network 99. The communication unit communicate using one or more communication protocols such as TCP/IP, Wi-Fi, LTE, 5G, or other communication protocol. In some aspects, the communication module can include a power line communication transceiver that communicates to the network over the AC bus.

A user can approach a kiosk and request that a battery pack be released (e.g., in performance of a swap), using an application on a user device 92, and/or through a user interface 96 of the kiosk. The user interface can include one or more input devices such as a keypad, buttons, microphone, camera, and/or touchscreen display, that takes a user input to request a battery pack. The user device can be a mobile phone, a tablet computer, a laptop, a head-worn device, smart glasses, a vehicle computer, or other mobile electronic device, that can include any of the one or more input devices mentioned above.

In some embodiments, a user can request that a battery pack be reserved at certain times. Processing logic can grant or deny the user request for releasing or reserving a battery pack depending on different criteria, as described in other sections. In some embodiments, the user can input a passcode through the user interface to release a battery pack. The pass code can be provided to the user by processing logic. For example, if the processing logic grants a user request to release or reserve a battery pack, processing logic can send the passcode to the user through the user device (e.g., to an email address of the user or as a notification to an application on the user device).

Charging and discharging of battery packs can generate thermal energy. A cooling system 97 can include one or more heat plates that are thermally coupled to each battery holder. The heat plates can be liquid-cooled, and/or fan-cooled. For a liquid-cooled system, the system can include cooling loops to transport liquid to and from each heat plate, one or more pumps to circulate the fluid. In some embodiments, a chiller or refrigerator can be used to chill the fluid. In some embodiments, the cooling system can include one or more fans that blow air on the heat plates, which can include fins to increase surface area for thermal transfer. Other cooling systems can be included and implemented to meet the varying needs of the battery packs without departing from the scope of the present disclosure.

The system can include one or more switches such as a switches 84 and 86. One of more of the switches, such as switch 84, can connect and disconnect the AC bus to a source 88. Source 88 can be a utility grid, a local inverter connected to a local source such solar panels or wind turbine, a generator, or other electrical energy source. One of more of the switches, such as switch 86, can connect the AC bus to one or more loads 90. The kiosk may include one or more electric outlets that connect to the AC bus (e.g., through switch 86 or directly). A user may connect certain loads to these outlets such as back up lighting, refrigeration equipment, medical equipment, point of sales, computing equipment, or other equipment deemed to be important or requiring uninterrupted power. Processing logic can control the switches to be normally closed under normal operation (e.g., grid is present). In some cases, if the grid goes down, and/or if the voltage or phase on the grid falls out of a predefined range, then processing logic can open switch 84 to protect components on the AC bus. Similarly, if a short or overvoltage is sensed on the load, switch 86 can be opened. In some cases, switch 86 and/or switch 84 can each include a plurality of switches to a plurality of sources and/or loads.

Sensing whether a power source on the AC bus is present or absent can be performed based on one or more algorithms that use voltage and/or phase adjustment of any of the bidirectional inverters. For example, one or more of the bidirectional inverters can adjust their phases slightly to determine which direction current is flowing, to determine if an AC power source is present on the AC bus. The system can include sensors 95 such as current sensors and voltage sensors. Current sensors and/or voltage sensors can be located between any of each DC stage and the battery pack, each AC stage and the AC bus, each power source and the AC bus, and each load and the AC bus.

Processing logic can control one of more of the bidirectional inverters to direct the energy to the AC bus from the battery pack in the respective one of the plurality of battery holders in response to an absence of the utility grid or other source. For example, if source 88 becomes absent, then one or more of the bidirectional inverters can be controlled to direct energy from a battery pack to the AC bus, to power one or more loads 90. Thus, the loads can operate without interruption, or this interruption can be reduced.

Additionally, or alternatively, processing logic can direct energy to the AC bus from the battery pack in the respective one of the plurality of battery holders at one or more predefined times. For example, some utility services allow for a user to put energy back on the grid, and the utility may reward the user with money or credits, based on how much energy is put back on the grid. The bidirectional inverter can put energy back on the grid by adjusting the phase of the AC bus to be ahead of the source AC by an offset amount. The power transfer amount can be proportional to the phase offset.

Each of the bidirectional inverters can be configured to operate individually to charge the battery pack in the respective one of the plurality of battery holders using energy from the AC bus. Similarly, each of the plurality of bidirectional inverters is configured to operate individually to discharge the battery pack in the respective one of the plurality of battery holders by directing energy to the AC bus. Processing logic can determine a state of charge (SOC) of a battery pack and charge the battery pack until it satisfies a threshold (e.g., 90% SOC, 95% SOC, etc.). The SOC can be determined by a BMS of the battery pack and obtained by processing logic. Each battery pack can have BMS that monitors each individual cell's state of charge based on one or more of: tracking the current into and out of each individual cell, the current into and out of the battery pack as a whole, the open circuit voltage of each cell, and the number of cycles of each cell. The BMS can determine overall battery control, state of charge (SOC), state of health (SOH) of the battery, and state of power (SOP) of the battery through one or more SOC, SOH, and SOP algorithms. In some embodiments, a BMS can also perform higher level control and management, data management (e.g., data acquisition and communication of data), wireless communication, power line communications, and over the air (OTA) software updates.

The BMS of a battery pack can communicate state of health (SOH) for that battery pack to processing logic. SOH can be determined based on one or more factors such as battery cycling history (e.g., how many cycles have been performed with the battery), battery storage temperature, one or more lookup tables (which can be provided by a manufacturer and/or determined through test and experimentation), and open circuit voltage of a cell or the battery pack. Based on SOH, processing logic may determine whether the lock is to release a battery pack to a user, allow a user to reserve the battery pack, or withhold the battery pack.

For example, if the SOH of a battery pack is below a threshold, then processing logic can withhold this battery pack to take it out of circulation, thereby preventing a user from taking or reserving the battery pack. This can help prolong the battery pack, improve reliability of those battery packs that are in circulation, and hold such battery packs for repurposing and/or servicing. SOC and SOH can be determined by the BMS and/or processing logic through various techniques without departing from the scope of the disclosure.

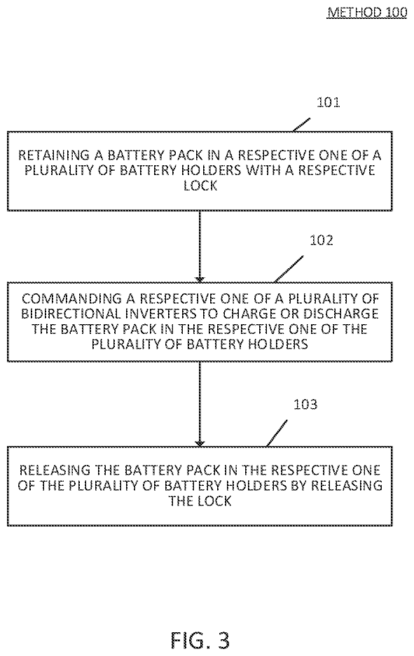

FIG. 3 shows a method 100 for battery storage and allocation, according to some embodiments. The method may be performed by processing logic, such as processing logic described with respect to FIG. 1 and FIG. 2, that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

The method illustrates example functions used by various embodiments. Although specific function blocks (“blocks”) are disclosed in method 100, such blocks are examples. That is, embodiments are well suited to performing various other blocks or variations of the blocks recited in method 100. It is appreciated that the blocks in method 100 may be performed in an order different than presented, and that not all of the blocks in method 100 may be performed.

At block 101, the method includes retaining a battery pack in a respective one of a plurality of battery holders with a respective lock. Once a user places a battery pack into the battery holder, processing logic can automatically lock the battery pack and keep the lock in place, thereby retaining the battery pack. In some cases, the lock can be spring loaded.

At block 102, the method includes commanding a respective one of a plurality of bidirectional inverters to charge or discharge the battery pack in the respective one of the plurality of battery holders. As described in other sections, each of the plurality of bidirectional inverters has an alternating current (AC) stage that is electrically coupled to an AC bus that is common to all of the plurality of bidirectional inverters. Similarly, each of the bidirectional inverters also includes a direct current (DC) stage that is electrically coupled to the battery pack in the respective one of the plurality of battery holders. The bidirectional inverters can include features as discussed in other sections.

At block 103, the method includes releasing the battery pack in the respective one of the plurality of battery holders by releasing the lock. The lock can include features as discussed in other sections. As such, the method provides an automated storage and allocation service for users to drop off and pick up battery packs. These battery packs can be operated to charge as well as discharge, thus allowing the battery packs to behave as a back-up energy storage for a user.

As discussed, the bidirectional inverters can be controlled individually, depending on one or more factors such as SOC, SOH, and/or whether the power source (e.g., a grid) is present on the AC bus.

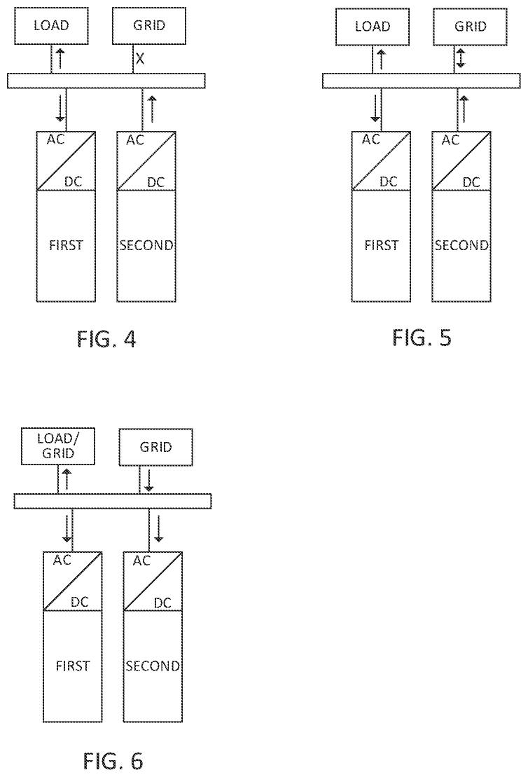

For example, referring to FIG. 4, if the power source (e.g., a grid) is not present on the AC bus, then one or more second battery packs can deliver power to the AC bus, while one or more first battery packs are charged from the AC bus. Processing logic can select the one or more second battery packs to be discharged, for example, based on them having a relatively higher SOC. Similarly, processing logic can select the one or more first battery packs to be charged, for example, based on them having a relatively lower SOC.

In such a manner, one or more of the battery packs that need to be charged can be charged, from one or more of the other battery packs, even without external grid support. For example, two second battery packs can charge a first battery pack to a sufficient SOC so that it can be made available to a user to take. The second battery packs can be withheld until they are charged when the grid returns. This is just one example of how the system can allocate batteries in a flexible manner, such as under conditions where grid power is unreliable.

Battery packs with higher energy can be used to charge the battery packs with lower energy. Additionally, or alternatively, the second battery packs can serve as back-up storage to power loads. In some embodiments, some batteries that have low SOH can be reserved for backup power, and thus, selected as the one or more second battery packs used to for back-up. The SOC or SOH can be determined relative to the other battery packs that are retained, and/or based on an absolute measurement.

In some embodiments, as shown in FIG. 5, when grid is determined to be present, then power can be delivered to the grid (e.g., during one or more predetermined times). Alternatively, power can be taken from the grid to power the load and/or one or more of the battery packs such as the first battery pack. For example, depending on the SOC and/or SOH, processing logic can select a second battery pack and command the bidirectional inverter that is associated with this battery pack to deliver power to the grid, while commanding the bidirectional inverter associated with the first battery pack to charge the first battery pack. In some embodiments, as shown in FIG. 6, if the grid is present, then all battery packs can be charged as needed, such as if the SOC of a battery pack is below a threshold amount. When grid power becomes unavailable, then processing logic can make less or none of the battery packs available.

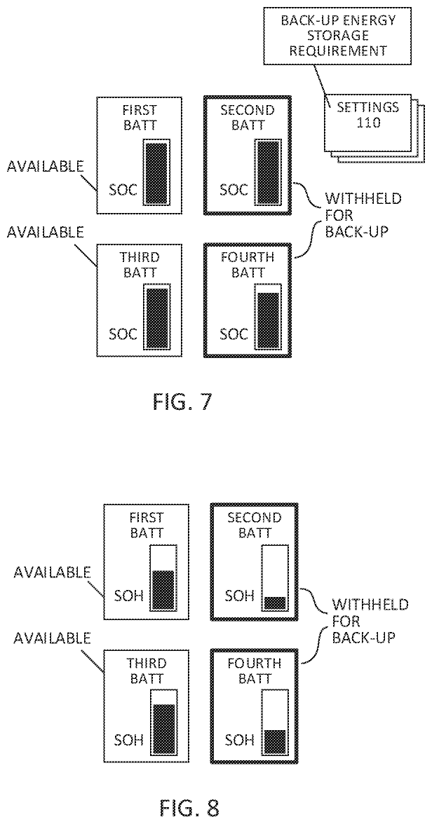

FIG. 7 shows an example of allocating battery packs based on maintaining a back-up energy storage requirement, according to some embodiments. Processing logic can withhold one or more of the battery packs that are retained in the battery holders, based on maintaining a total energy storage of the battery packs. Processing logic can access settings 110 that can include the backup energy storage requirement. Processing logic can allocate the battery packs by determining how many battery packs can be released, if any, such that the combined backup energy storage in the remaining battery packs would satisfy the backup energy storage requirement.

For example, settings may define the back-up energy storage requirement as 2 kWh. If each battery pack has 1 or more kWh, processing logic can withhold the second and fourth battery pack, and make the first and third battery pack available. In such a case, if a user requests two battery packs to be released or reserved, processing logic can grant this request, because the system would still have at least 2 kWh in energy storage that can be used for back-up energy (e.g., in case of a utility grid failure).

If, however, the back-up energy storage requirement is 4 kWh, processing logic can determine that all of the battery packs that are currently being held in the battery holders are to be withheld to satisfy the requirement. As such, processing logic can reject the user's request to reserve or release a battery pack. If, however, an additional battery pack is placed in another battery holder of the system, totaling five battery packs, then processing logic can make one of the battery packs available, so long as the remaining four battery packs satisfy the back-up energy storage requirement. Processing logic can send a notification to the user that a battery pack is now available (e.g., through an email or a notification on an application).

Settings 110 can include data is associated with users that swap batteries, as well as users that use the system for back-up energy storage. For example, settings 110 can include a username and contact information such as phone number and email for users that swap batteries. Processing logic can access this contact information to send a user a notification such as when a battery pack is available. Further, back-up energy storage users can define their back-up energy storage requirements (e.g., 1 kWh, 2 kWh, etc.). Settings can be stored in computer-readable memory that resides on a networked computing device and/or stored locally in a kiosk.

As discussed, the system can include a plurality of battery holders that are housed in a kiosk. The kiosk can be located in a shop, booth, or other location, to help draw business and foot traffic to the location. A user can connect one or more loads to the AC bus of the kiosk and define the back-up energy storage requirement to suit such loads. Thus, the system can help users who need a battery swap and users who need back-up energy storage. The total combined energy storage of the battery packs can be determined based on the current state of charge of each battery pack, or a capacity of the battery pack.

For example, if the battery pack is currently holding 0.5 kWh, but can hold 1 kWh at 90% SOC, then the current state of charge (e.g., 0.5 kWh) can be used if a user requests to release the battery pack immediately. If, however, the user wishes to reserve the battery pack for release at a later time, then a capacity of the battery pack (e.g., at 90% SOC) can be used to determine how much energy this battery pack contributes to satisfy the back-up energy storage requirement. Other variations can be implemented by processing logic without departing from the scope of the disclosure.

In some embodiments, as shown in FIG. 8, processing logic can withhold one or more of the battery packs, based on a state of health (SOH) of the one or more of the battery packs. For example, battery packs with low SOH, or a SOH below a threshold, may not be suitable for vehicle application, due to higher internal resistance and limited capacity, but may be suitable as for back-up applications that require less power cycles, lower performance, and/or lower power demand. For those battery packs where the SOH does not satisfy a threshold, these can be reserved for back-up. Additionally, or alternatively, processing logic can prioritize releasing a battery pack based on SOH. Those with higher SOH are released to users ahead of those with lower SOH. Those with lower SOH can be prioritized for back-up energy.

In some embodiments, processing logic is to withhold one or more of the battery packs, based on absence of a utility grid. A user may specify in the settings whether a) all battery packs are to be withheld when grid is down, or b) some battery packs can be made available when the power source is absent, so long as that a back-up energy storage requirement is maintained. In some aspects, if a utility grid and/or other power source is detected to be absent, and settings are configured to reserve one or more of the battery packs for back-up energy storage (e.g., a back-up energy storage requirement is set), then processing logic may withhold some or all of the battery packs from being released or reserved. Otherwise, if no back-up energy storage requirement is set, then processing logic can allow battery packs to be released or reserved, even if a power source is down.

In some embodiments, processing logic can receive a user request to reserve or release one or more of the battery packs. As described, a user can make a request with a mobile device, a computer, a user interface on a kiosk, or other input device. Processing logic can receive the request and accept or deny the request based on at least one of: based on maintaining a total energy storage of the battery packs that are each in the respective one of the plurality of battery holders, a state of health of the one or more of the battery pack s, a state of charge of the one or more of the battery packs, and based on absence of a utility grid.

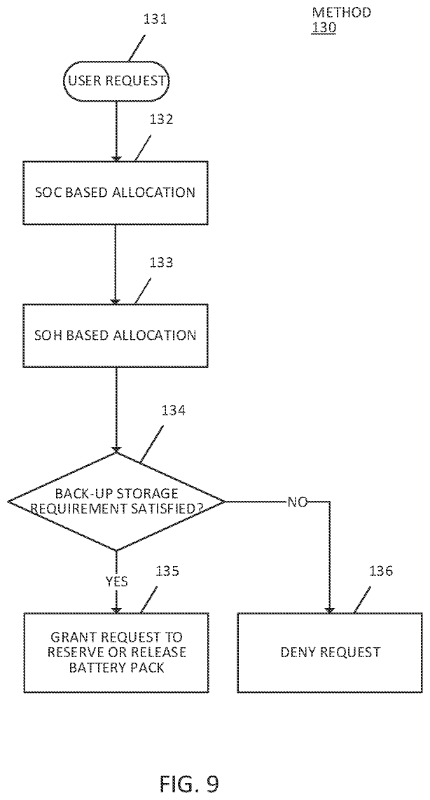

FIG. 9 shows method for granting or denying a request to reserve or release a battery pack based on criteria, according to some embodiments. The method may be performed by processing logic, such as processing logic described with respect to FIG. 1 and FIG. 2, that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

The method illustrates example functions used by various embodiments. Although specific function blocks (“blocks”) are disclosed in method 130, such blocks are examples. That is, embodiments are well suited to performing various other blocks or variations of the blocks recited in method 130. It is appreciated that the blocks in method 130 may be performed in an order different than presented, and that not all of the blocks in method 130 may be performed.

At block 131, processing logic receives a user request to release or reserve a battery pack. At block 132, processing logic can determine which battery packs have sufficient SOC to be made available. Those that have sufficient SOC can be considered at block 133, while those that do not can be marked for withholding. Battery packs can be prioritized for release based on which have the higher SOC.

At block 133, battery packs can be prioritized based on SOH. Those with higher SOH can be prioritized for release, while those with lower SOH can be prioritized to be withheld.

At block 134, processing logic can determine whether granting the user request would reduce the total energy storage of the remaining combined battery packs such that a back-up storage requirement is no longer satisfied. If that is the case, then processing logic can proceed to block 136 and deny the request. If a back-up storage requirement is not set as active, or the back-up storage requirement would still be satisfied if the user request is granted, then processing logic can proceed to block 135 and grant the request to reserve or release the one or more battery packs. The user's request can specify how many battery packs the user wishes to obtain.

At block 135, the battery packs can be released based on priorities determined at block 132 and 133. The one or more battery packs which are determined at block 132 as having insufficient SOC can be withheld. For example, if the four battery packs are retained, and one of the battery packs has an SOC of 5%, this can be withheld. Of those four battery packs, the battery pack with highest combined SOC and SOH can be released. The SOC and SOH can be weighted to emphasize one over the other.

As such, a kiosk can allocate the most charged batteries to users for swapping, while reserving those with low health for back-up purposes, and providing a back-up energy source to a user, if desired.

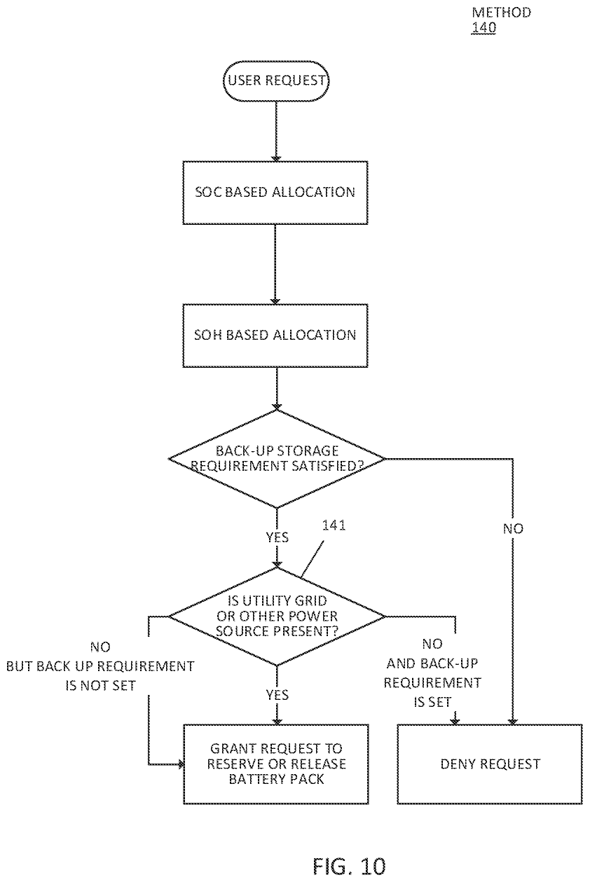

FIG. 10 shows method 140 for granting or denying a request to reserve or release a battery pack based on criteria that includes grid presence, according to some embodiments. The method may be performed by processing logic, such as processing logic described with respect to FIG. 1 and FIG. 2, that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

The method illustrates example functions used by various embodiments. Although specific function blocks (“blocks”) are disclosed in method 140, such blocks are examples. That is, embodiments are well suited to performing various other blocks or variations of the blocks recited in method 130. It is appreciated that the blocks in method 140 may be performed in an order different than presented, and that not all of the blocks in method 140 may be performed.

Method 140 can include some or all features described with respect to method 130, as well as those described in other figures. In addition, at block 141, processing logic can detect whether a power source such as the utility grid is present (e.g., electrically coupled to the AC bus of the system). If yes, then processing logic can proceed to grant the user request. If not, then processing logic can still grant or deny the request, based on whether the back-up energy storage requirement is set, as described in other sections.

In such a manner, even if the system has a sufficient amount of battery packs and energy stored in those battery packs for back-up energy, it may be desirable to withhold all battery packs because it is uncertain when the power source can return.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, a thermal connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A system for battery management, comprising:
a plurality of battery holders;
a plurality of locks, each being operated by processing logic to retain or release a battery pack in a respective one of the plurality of battery holders;
a plurality of bidirectional inverters, each having an alternating current (AC) stage that is electrically coupled to an AC bus that is common to all of the plurality of bidirectional inverters, and a direct current (DC) stage that is electrically coupled to the battery pack in the respective one of the plurality of battery holders.

2. The system of claim 1, wherein each of the plurality of bidirectional inverters is configured to operate individually to charge the battery pack in the respective one of the plurality of battery holders using energy from the AC bus.

3. The system of claim 1, wherein each of the plurality of bidirectional inverters is configured to operate individually to discharge the battery pack in the respective one of the plurality of battery holders by directing energy to the AC bus.

4. The system of claim 3, wherein the energy is directed to the AC bus from the battery pack in the respective one of the plurality of battery holders in response to an absence of a utility grid.

5. The system of claim 3, wherein the energy is directed to the AC bus from the battery pack in the respective one of the plurality of battery holders at a predefined time.

6. The system of claim 1, wherein the processing logic is to withhold one or more of the battery packs based on maintaining a total energy storage of the battery packs that are each in the respective one of the plurality of battery holders.

7. The system of claim 1, wherein the processing logic is to withhold one or more of the battery packs, based on a state of health of the one or more of the battery packs.

8. The system of claim 1, wherein the processing logic is to withhold one or more of the battery packs, based on a state of charge of the one or more of the battery packs.

9. The system of claim 1, wherein the processing logic is to withhold one or more of the battery packs, based on absence of a utility grid.

10. The system of claim 1, wherein the processing logic receives a user request to reserve or release one or more of the battery packs, and the user request is accepted or denied based on at least one of: based on maintaining a total energy storage of the battery packs that are each in the respective one of the plurality of battery holders, a state of health of the one or more of the battery packs, a state of charge of the one or more of the battery packs, and based on absence of a utility grid.

11. A method performed by processing logic, comprising:
retaining a battery pack in a respective one of a plurality of battery holders with a respective lock;
commanding a respective one of a plurality of bidirectional inverters to charge or discharge the battery pack in the respective one of the plurality of battery holders, each of the plurality of bidirectional inverters having an alternating current (AC) stage that is electrically coupled to an AC bus that is common to all of the plurality of bidirectional inverters, and a direct current (DC) stage that is electrically coupled to the battery pack in the respective one of the plurality of battery holders; and
releasing the battery pack in the respective one of the plurality of battery holders by releasing the lock.

12. The method of claim 11, wherein each of the plurality of bidirectional inverters is controlled to operate individually to charge the battery pack in the respective one of the plurality of battery holders using energy from the AC bus.

13. The method of claim 11, wherein each of the plurality of bidirectional inverters is controlled to operate individually to discharge the battery pack in the respective one of the plurality of battery holders by directing energy to the AC bus.

14. The method of claim 13, wherein the energy is directed to the AC bus from the battery pack in the respective one of the plurality of battery holders in response to an absence of a utility grid.

15. The method of claim 13, wherein the energy is directed to the AC bus from the battery pack in the respective one of the plurality of battery holders at a predefined time.

16. The method of claim 11, comprising preventing release of one or more of the battery packs based on maintaining a total energy storage of the battery packs that are each in the respective one of the plurality of battery holders.

17. The method of claim 11, comprising preventing release of one or more of the battery packs, based on a state of health of the one or more of the battery packs.

18. The method of claim 11, comprising preventing release of one or more of the battery packs, based on a state of charge of the one or more of the battery packs.

19. The method of claim 11, comprising preventing release of one or more of the battery packs, based on absence of a utility grid.

20. A battery kiosk, comprising:
a plurality of battery holders;
a plurality of locks, each being operated by processing logic to retain or release a battery pack in a respective one of the plurality of battery holders;
a plurality of bidirectional inverters, each having an alternating current (AC) stage that is electrically coupled to an AC bus that is common to all of the plurality of bidirectional inverters, and a direct current (DC) stage that is electrically coupled to the battery pack in the respective one of the plurality of battery holders.
